(19) United States
(12) Patent Application Publication
(10) Pub. No.: US 2011/0042959 A1
(43) Pub. Date: Feb. 24, 2011

(54) Wind Energy Conversion Apparatus

(76) Inventor: Samuel Thomas Kelly, San Marcos, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/546,057

(22) Filed: Aug. 24, 2009

(51) Int. Cl. F03D 9/02

(52) U.S. Cl. 290/55

(57) ABSTRACT

An apparatus and method to efficiently convert erratic wind energy to a source of reliable standard AC electrical power by means of a complex tower-mounted windmill operatively engaged to power a pump. The pump in a sealed communication with a chamber evacuates air from the chamber to store the wind-generated energy as potential energy in the form of a pressure differential with ambient atmosphere. Regulated air inflow into the evacuated chamber is employed to drive a generator to produce electric power which is synchronized with the grid on demand.

### FIELD OF THE INVENTION

The device and method of employment thereof herein described relates to windmills. More particularly it relates to a novel construction and method of operation of a windmill energy generation field allowing for a variable mount to the turbine and blades and the storage of wind energy in a vacuum which may be accessed by the user or energy provider as needed to generate electrical power.

### BACKGROUND

The industry providing renewable energy and wind derived energy in particular, is growing steadily both in the U.S. and worldwide. In the United States, public policy is continuing to evolve toward the employment of renewable energy sources for electrical power generation rather than using fossil fuels and water power from dams, as has been done in recent decades.

Many states, as well as the Federal Government, encourage the use and development of renewable power sources through grants and available funds for energy development projects. Ever increasing state mandates for renewable energies and environmental regulations continue to increase the use of such renewable technology, which has increased the demand for and the number of wind farms, for electrical power generation. However, in spite of the fact that the blades and other components of windmills have evolved greatly and thus improved the power production of windmills, it is widely regarded that wind power has not realized its full potential.

Currently, new renewable energy facilities for electrical power generation are largely financed with private capital in combination with subsidies and various incentives from government. Such facilities produce alternating current which is fed into power transmission lines across the country at matching voltages and frequencies.

The North American “grid” of electrical transmission lines is overseen by the Federal Energy Regulatory Commission (FERC), an independent agency under the Department of Energy. FERC is self funding, recovering costs from the industries it regulates. Renewable energy production, such as that produced by wind energy, feeds into the grid under regional organizations such as Independent System Operators (ISOs) that further serve utilities and such. Because generation capacity of wind turbines varies, depending on the amount of wind, and power requirements of the grid system vary by time of day, the peak production of a windmill may not match the peak power requirements of the grid to which it is engaged.

Besides the load requirements of the local grid there is an economic factor at work in the production of electrical power provided to the grid system. When load requirements are high the cost of power provided the grid will generally rise and conversely, when load requirements drop, the price paid for wind generated power may also drop. In some cases, that drop in price may be below cost, so it would be beneficial if the generation capability of a windmill can be stored to provide power much like small generators, which utilities employ as peak generators, when load requirements are very high.

Like wind farms, electrical storage facilities may be operated by private business to buy energy from the market when the price is low or negative, and sell it back to the market when the price is high. For this strategy to be successful, it would be necessary to have a significant volatility in real time energy prices. Also, the volume of energy storage for such a facility must be at least three times the capacity of the unit generating the power being stored. For instance, a 10 MW facility would need 30 MW/hr of storage capability.

Also necessary for a successful energy storage facility would be a means for very efficient storage and the ability to transmit the electrical power in a round trip with energy losses of 10% or less.

Also generally accepted as required for a successful electrical storage facility is a capital cost per 1000 kW/hr which is below one million dollars. In the case of a wind farm, in order to successfully store power, a rapid response to sudden wind gusts and lulls is also a requirement.

However, currently the inability to meet the noted criteria for a successful wind energy storage facility, and thus show a profit on operations once built, has deterred private investment in expansion of existing technologies as well as construction of new energy storage facilities. Still further, there is currently no market or tariff charged upon produced energy to pay for energy storage development.

As a consequence, in order to show predictable profits on operations which will interest private investment, electrical and other energy storage must add greater value on its own, or it must be integrated into other cost effective wind energy gathering systems.

In the area of wind power generations, wind turbines, a conventional type have evolved to dominate the wind power industry. Such turbines have improved with incremental design advances over the years, such that, when combined with tax incentives and other subsidies, power produced by wind farms in some locations can now compete with other means of energy production.

The primary focus in windmill deployment has been to make the wind intercept area larger and larger. As the size of the wind turbines increases, problems increase similarly so the energy gains versus the cost increases begin to limit improved value more and more.

Although it is known that wind power increases with its elevation above ground, problems increase as towers become taller. The materials used for towers increase by a factor of eight to one as the tower becomes taller. Wind load on the tower base increases by the square of the height of the turbine. Damage to the foundation may occur caused by the vibrations transmitted from the propellers as they engage the wind-driven power generator due to the dynamic loads, unless special steps are taken to dampen these vibrations. Thus, to take advantage of the stronger winds at higher elevations and improve the energy gathering of the wind, the problems of very tall towers must be addressed.

Wind turbines inherently produce variable frequency AC power. Older design wind turbines were made to rotate at a constant speed to match the power line voltage and frequency which allowed them to use less costly induction generators, but they were inefficient at converting wind energy to electric power. Modern wind turbine generators are designed to rotate at whatever speed generates electricity most efficiently. However, to match up with power line voltage and frequency with that of the wind turbine, technologies such as doubly fed induction generators or full-effect converters where variable frequency power is converted to DC and then back to AC must be employed. Such requirements involve costly equipment and loss of power.

As such there is an unmet need for a windmill design which will allow for vertical adjustment of the blades and turbines to operatively position them in the optimum position for oncoming wind. Such a system should concurrently provide the benefits of a lowering system for construction and maintenance of the windmill components. Further, such a system and apparatus should provide for a means to accommodate the widely variable aspects of wind to generate the maximum amount of electrical energy in peak winds, but to store the energy to produce electrical power during peak grid requirements or peak pricing points for power providers. Such a system thereby will allow for wind farms to provide a more constant flow of profitable energy production by generating the maximum amount of wind energy when possible, and using the system of storage to provide either a buffer for peak grid requirements or to store energy when unneeded or prices are low so it may be sold when prices are increased or need is acute.

In this respect, before explaining at least one embodiment of the windmill construction and method of operation invention in detail it is to be understood that the invention is not limited in its application to the details of construction and to the arrangement of the components set forth in the following description or illustrated in the drawings. The invention is capable of other embodiments and of being practiced and carried out in various ways.

Also, it is to be understood that the phraseology and terminology employed herein are for the purpose of description and should not be regarded as limiting. As such, those skilled in the art will appreciate that the conception, upon which this disclosure is based, may readily be utilized as a basis for designing other windmill suspension and elevation systems and storage of wind energy systems for carrying out the several purposes of the present invention. It is important, therefore, that the claims be regarded as including such equivalent construction insofar as they do not depart from the spirit and scope of the present invention.

An object of this invention is the provision a windmill which provides for a variable positioning above the ground surface for construction and maintenance.

An additional object of this invention is the provision of such a storage system for wind energy which does not require batteries or other electrical means for energy storage.

It is a further object of the invention herein, to provide such a wind energy operation and storage system which will allow windmill farms to operate more profitably by allowing for storage of wind energy produced during peak wind periods for sale and use at times when grid requirements and/or prices are higher.

These together with other objects and advantages which will become subsequently apparent reside in the details of the construction and operation as more fully hereinafter described and claimed, reference being had to the accompanying drawings forming a part thereof, wherein like numerals refer to like parts throughout.

### SUMMARY AND OBJECT OF THE INVENTION

The present invention herein disclosed concerns an enhanced wind energy conversion system which will lower the costs of producing electricity in light winds. As a consequence, the system will allow currently marginal wind locations, to become cost effective as sites for wind parks for power generation.

To be cost effective existing wind turbines and wind farms require locations which have strong winds that blow a majority of the time. These “good” wind locations are often far from cities where the power is needed, and as a consequence, they require long transmission lines, which are costly and suffer significant power line losses.

To improve the conventional situation, the device and method herein allow for an increase in the number of “distributed” power sources where power is produced closer to the energy users in the cities. To accomplish this, the device and method herein allow for the more profitable production of wind power in the lighter winds found on locations closer to urban environments where power is used.

Instead of the conventional tall towers supporting ever larger windmill blades and turbines, the device herein allows for the economical construction of concrete silos or the like. The silos, so constructed, provide elevated platforms to support windmills engaged upon translatable mounts, allowing the windmills to be positioned at very high elevations above the ground. So positioned, they intercept the more powerful winds, which occur at these greater elevations.

However, these silos have a secondary function. In addition to supporting the blades and turbines of the windmill, the silos are adapted to serve as storage chambers to store wind energy, no matter when generated, in the form of a contained vacuum. This allows for the storage of wind energy, without batteries or other electronic storage means, and for the timely generation of electrical power to maximize both profitability and provision of power for peak grid requirements, which rarely occur when the highest winds are available for power generation.

In a preferred mode of the invention, a windmill replaces a wind turbine. As a consequence, instead of generating variable frequency AC, the windmill is employed to drive a vacuum pump to evacuate air from the silos supporting the windmill and thereby to create a reservoir of potential energy for use at the most opportune times.

The free running pump operatively engaged to the blades of the windmill, instead of a conventional turbine, reduces the stresses on power transmission components caused by lulls and gusts in the wind. This is a particularly taxing element of conventional wind farms using turbines for power generation. By reducing equipment stresses, the maintenance costs are reduced and equipment life is increased.

Additionally, since the wind in any given locale is unpredictable, and in general blows as much in times of low demand as it does at times of high demand, the power conventional wind turbines produce in these off times is often less value than when demand is high. This is because there is no economical means to store electrical energy in large volume for insertion to the grid at more opportune time frames. The device and method herein provide a means to store the energy produced at inopportune and communicate it to the grid as needed for peaks or when prices are higher. Thus the storage element of the system helps balance a supply and demand mismatch by saving electric power when it is less needed, to be inserted into the power grid at times when it is needed more.

Such large volume wind energy storage is accomplished by employing the stored vacuum housed in the silos or other sealed containment structures. Using the vacuum, and a timely directing of ambient air to drive a turbine as the air refills the evacuated silo, electrical power may be generated at times scheduled to produce more profit or to provide grid peaks which would normally require a peak generator to come on line. Additionally, when the flowing air is regulated, the electrical output of the turbine can be made to match the frequency and voltage of the power grid in an economical and reliable way. Instead of expensive electronic equipment employed with conventional tower mounted turbines, the device and method herein allow for lower costs by matching power and frequency between the vacuum generated power and that of the power grid.

In the disclosed device, the silo provides a pocket wherein the tower support structure for the windmill is positioned in a translatable engagement with the silo. Tower translation allows for ease of initial construction and subsequent maintenance by retracting the tower to lower elevations. Translation to operating positions may be done at any time and any elevation between the retracted position and peak position to take advantage of the best wind at certain elevations.

Those skilled in the art will recognizing that there are numerous types of lifting components capable of elevating the tower and windmill and that the invention describes only one example. Any such lifting means, as would occur to those skilled in the art, is anticipated by this application.

The tower member, when employed with silos doubling as the vacuum reservoir, is fitted with an annular seal allowing the tower member to slide vertically on the inner surface of the silo in the manner of a piston. Not illustrated, is an air compressor and valving as may be required to provide pneumatic lift to elevate the windmill on the translating tower member when pressure is introduced under the annular seal.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the following drawings and as described in the specification, are intended to be encompassed by the present invention. Therefore, the foregoing summary and description and following detailed description are considered as illustrative only of the principles of the invention.

Further, upon reading the disclosure herein, numerous modifications and changes will readily occur to those skilled in the art. It is not desired to limit the invention to the exact construction and operation shown and described herein, and accordingly, all suitable modifications and equivalents which may occur to those skilled in the art are considered to fall within the scope of the invention.

### BRIEF DESCRIPTION OF THE DRAWINGS

FIG. 1 depicts an operational arrangement of the system's component parts according to the embodiment of the present invention.

FIG. 2a depicts the device with the stanchion supporting the turbine translated to position the turbine in the elevated position.

FIG. 2b depicts the device with the support stanchion translated to position the turbine and blades in a retracted position.

FIG. 3 is a record of a representative twenty-four hour period of wind turbine actual and potential output.

FIG. 4 is a graphical representation of wind power available for power as a function of wind turbine height.

### DETAILED DESCRIPTION OF THE INVENTION

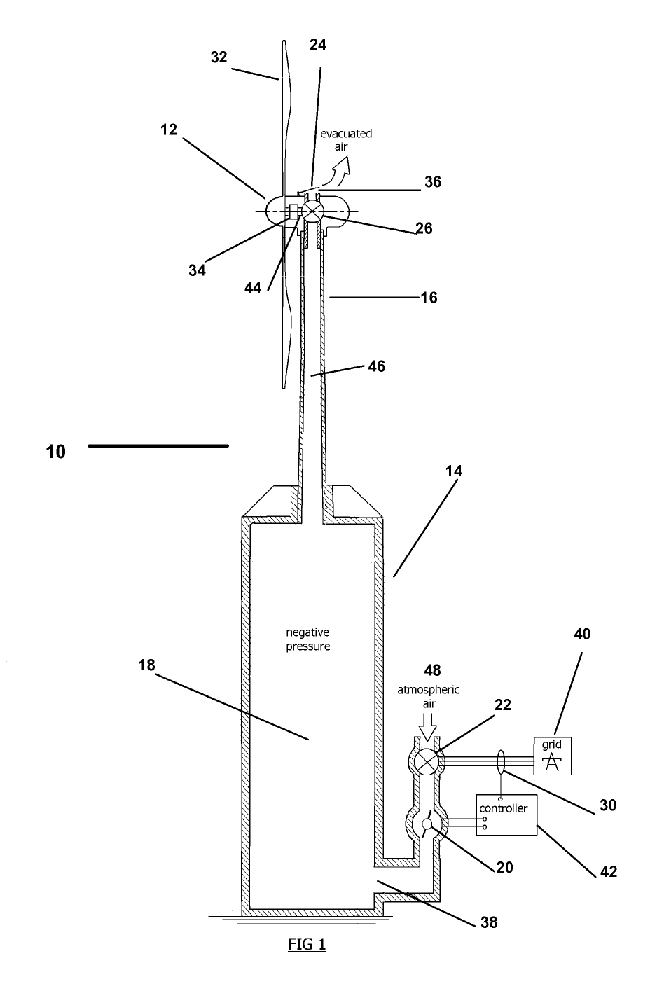

Referring now to the drawings depicting the method and device 10 in FIGS. 1-4, wherein similar parts are identified by like reference numerals, as noted FIG. 1 illustrates the system of the invention wherein a windmill assembly 12 which incorporates wind vanes 32 disposed to intercept prevailing winds. Also shown are a geared reduction component 34 and a means for pumping air or evacuating air from a closed cavity 18, such as an air pump 24.

The pump 24, is operatively engaged through a conduit 46 to evacuate air from an airtight reservoir means, such as the cavity 18 formed within the silo structure 14 in a preferred mode of the device herein. Those skilled in the art will realize that other cavities 18 or means for storage of negative air pressure might also be placed in communication with the pump 24 driven by the windmill assembly 12 or a plurality of such cavities 18 may be made available for evacuation of air therefrom. Consequently, the displayed cavity 18 is therefor illustrative of one mode of the device. As shown, and formed as part of the silo structure 14, the device is especially effective in conserving valuable ground space by using the silo structure 14 to both elevate the vanes 32 and pump 24 to operative positioning and providing a generally elongated and elevated cavity 18 within the silo structure 14 as a unit. This mode of the device is especially effective in that it may be manufactured in quantity and trucked to wind farms, and as noted, it saves valuable ground space in the windmill farm.

However, as noted, other cavities 18 may be engaged to the pump 24 through a conduit 46 or the like, and might be located in convenient locations such as underground, or adjacent to the device 10 and thereby provide a means to store the wind energy in the form of negative air pressure. In either mode, the cavity 18 storing the negative pressure provided by the wind powered pump 24 can be employed to generate electrical energy as needed by the grid or at times most profitable to the provider, or as a means to even out the total supply of energy provided by a windmill farm over time, to make up for periods of low wind.

The depicted cavity 18 of a preferred mode of the device 10, formed as a unit, is defined within the concrete silo structure 14. The cavity 18 communicates with the pump 24 through the conduit 46 formed within the hollow stanchion 16. The stanchion 16 is itself disposed to provide a means for translation and support for the windmill 12 to elevate the windmill to positions optimizing wind load or for maintenance.

A second port 38 is disposed to communicate in a sealed engagement with the cavity 18 and with atmospheric air 48. A controlling valve 20 is employed to regulate air flow into the cavity 18 and thereby provided means to control a turbine generator 22 during use of the device 10 to generate power from the stored negative pressure in the cavity 18.

A control module 42 with feedback loop 30 as to the grid voltage and occilations, services to control the valve 20 to regulate air flow to cause the turbine generator 22 to generate electrical power to match the grid 40.

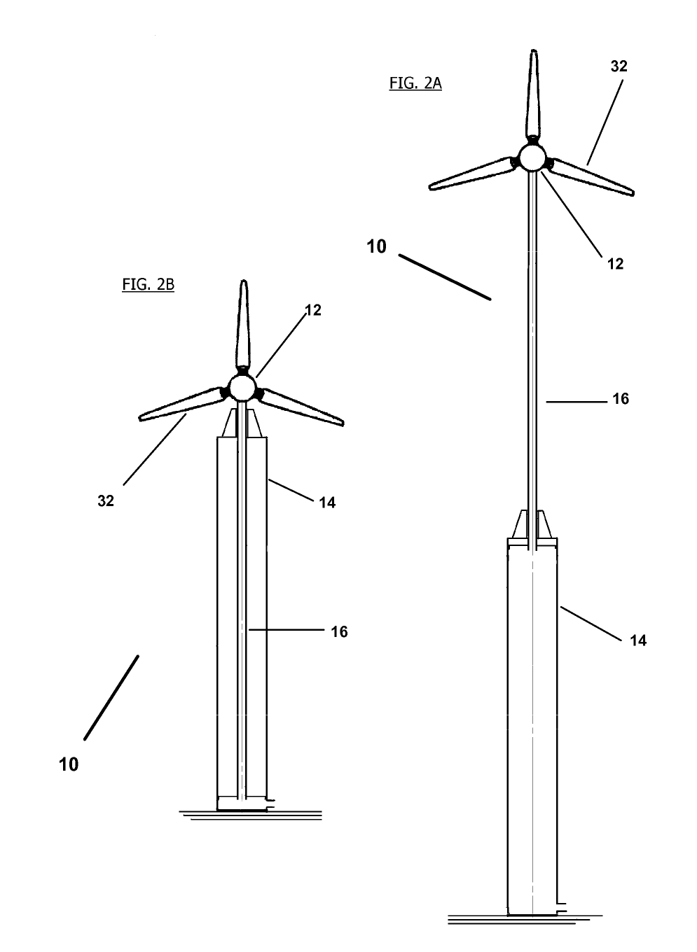

As shown in FIGS. 2a and 2b the windmill 12 may be elevated to operational height by powered translation of the stanchion 16 to position it at a height where the blades 32 intercept stronger winds to produce rotation of the impacted windmill blades 32. The rotary motion of the blades 32 provides the power to turn a shaft 44 the rotation of which is geared up by way of a gear box 34 which communicates power from the shaft 44 to a pump 26 for evacuation of air from the cavity 18.

The rotating pump 26 is adapted to draw air out of the sealed cavity 18 and vent it to atmosphere via an exhaust port 36 and a check valve disposed to prevent air from refilling the evacuated cavity 18 by way of an idled vacuum pump 24. The stanchion 16 supports the windmill assembly and has an axial conduit 46 to provide a passage for air evacuated from the cavity 18.

Stored wind energy in the form of negative pressure may thereafter be recovered and supplied to the power grid 40 in a controlled manner as needed by a programmed control module 42 actuating the valve 20 to release or impede air from refilling the evacuated cavity 18 under the differential pressure from the atmosphere via the alternate duct 15 and passing through the turbine generator 22 to generate electricity.

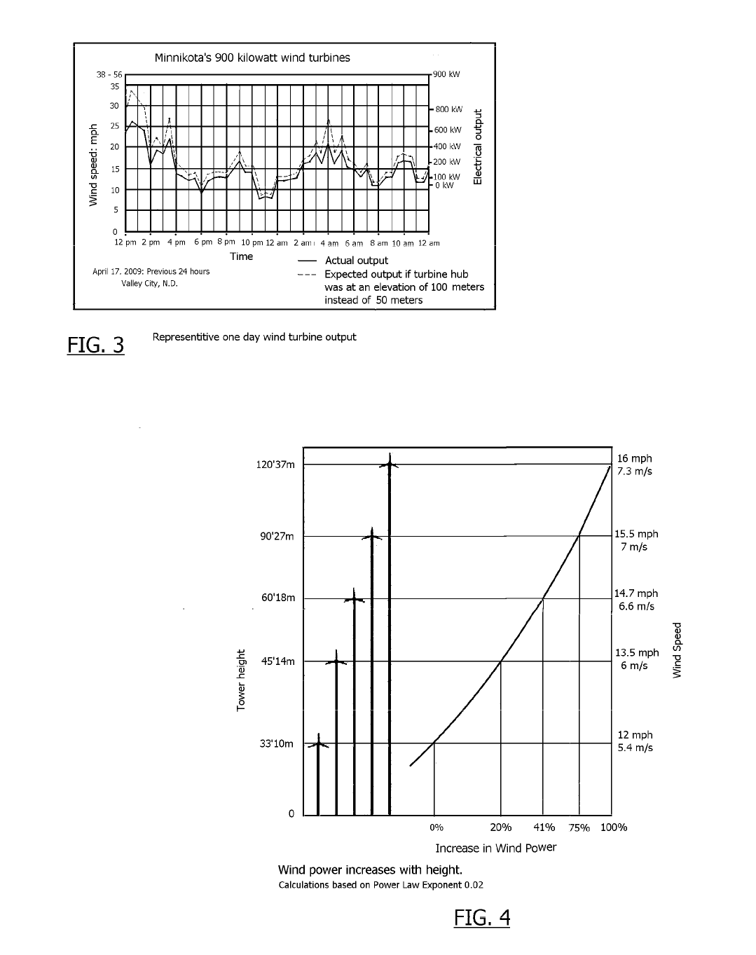

FIG. 3 is a record of a representative of conventional turbine output over a twenty-four hour period and a projected output in kilowatts if the wind turbine was positioned higher in the stronger winds at the greater height. As noted earlier, FIG. 4 is a graphical representation by the US Department of Energy showing the relationship between wind power and the height above ground of the windmill.

The device herein, as noted, may be employed to store wind energy from periods of high wind when the electrical power generated is of little use or may only be sold at a minimum price. The stored wind power may then be employed at a later time to power generators to either augment output of the windmill farm during periods of low wind speed, or as an independent means to produce electrical power at times of need or maximum selling price. In a method of such, the negative pressure in the cavities 18 would be created during periods of high wind, and then stored as potential energy for potential time durations. The stored energy amounts would be tracked and thereafter released as electrical energy by venting air into the cavities 18 during periods of high demand and insufficient output from the windmill farm, or periods when prices are high so as to generate more profit for the windmill operators.

While all of the fundamental characteristics and features of the windmill energy storage method and device have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are included within the scope of the invention as defined by the following claims.

What is claimed is:

1. A wind energy storage system for converting wind energy into usable electricity comprising:
a windmill having vanes adapted to intercept wind and impart power to rotate a drive shaft operatively engaged to said vanes, said windmill mounted upon a tower;
a sealed reservoir cavity adapted to maintain a pressure differential with ambient atmosphere exterior to said cavity;
a pump operatively engaged to said drive shaft of said windmill whereby said power imparted to said drive shaft provides means to power said pump to pump air received through and intake through said pump to an output;
said intake of said pump in a sealed communication with said reservoir; and
said pump powered by said windmill causing an evacuation of air from said reservoir through said intake thereby creating an increase in said pressure differential; and
means for rotation a generator or alternator, using a force of air communicating through an inflow to said reservoir, to generate electricity, whereby said power produced by said wind powering said windmill, during a duration of time, may be stored as said pressure differential in said reservoir for an employment to power said generator or alternator to generate said electricity.

2. The system of claim 1 wherein said tower piece has an axial cavity communicating therethrough providing said sealed communication between said pump and said reservoir.

3. The system of claim 1 additionally comprising:
means to control said inflow of air into said reservoir, whereby an output of electricity produced by said generator or alternator can be controlled.

4. The system of claim 2 additionally comprising:
means to control said inflow of air into said reservoir, whereby an output of electricity produced by said generator or alternator can be controlled.

5. The system of claim 1 additionally comprising:
said tower in a translatable engagement with said reservoir at a base end of said tower; and
said tower translatable to an elevated position elevated above said reservoir by said tower, and to a lowered position, wherein a portion of said tower is translated into said reservoir.

6. The system of claim 2 additionally comprising:
said tower in a translatable engagement with said reservoir at a base end of said tower; and
said tower translatable to an elevated position elevated above said reservoir by said tower, and to a lowered position, wherein a portion of said tower is translated into said reservoir.

7. The system of claim 3 additionally comprising:
said tower in a translatable engagement with said reservoir at a base end of said tower; and
said tower translatable to an elevated position elevated above said reservoir by said tower, and to a lowered position, wherein a portion of said tower is translated into said reservoir.

8. The system of claim 4 additionally comprising:
said tower in a translatable engagement with said reservoir at a base end of said tower; and
said tower translatable to an elevated position elevated above said reservoir by said tower, and to a lowered position, wherein a portion of said tower is translated into said reservoir.

9. The system of claim 5 additionally comprising:
means to inject compressed gas into said reservoir;
said tower being in a sealed said translatable engagement with said reservoir; and
whereby said compressed gas introduced into said reservoir provides means to translate said tower to said elevated position.

9. The system of claim 6 additionally comprising:
means to inject compressed gas into said reservoir;
said tower being in a sealed said translatable engagement with said reservoir; and
whereby said compressed gas introduced into said reservoir provides means to translate said tower to said elevated position.

11. The system of claim 7 additionally comprising:
means to inject compressed gas into said reservoir;
said tower being in a sealed said translatable engagement with said reservoir; and
whereby said compressed gas introduced into said reservoir provides means to translate said tower to said elevated position.

12. The system of claim 8 additionally comprising:
means to inject compressed gas into said reservoir;
said tower being in a sealed said translatable engagement with said reservoir; and
whereby said compressed gas introduced into said reservoir provides means to translate said tower to said elevated position.

13. The wind management system of claim 1 additionally comprising:
a check valve is positioned as a means to prevent atmospheric air from entering the vacuum chamber by way of said pump while inoperative.

14. The wind management system of claim 1 additionally comprising:
a controller means disposed to sense the electrical parameters of an accessible power line and regulate inflow to said reservoir powering said alternator or generator so as to provide matching said electrical parameters to said electricity when communicated to said power line.

15. The wind management system of claim 12 wherein said translation of said tower is adjustable to provide means to elevate the windmill to a position to intercept stronger winds.

16. The wind management system of claim 12 wherein the tower is translatable to a lowered position as a means to provide convenient servicing of the windmill at a position closer to said ground than said elevated position.
